(19) United States
(12) Patent Application Publication
(10) Pub. No.: US 2014/0334781 A1
(43) Pub. Date: Nov. 13, 2014

(54) Optical Connections

(71) Applicants: Marco Fiorentino, Mountain View, CA (US); Paul Kessler Rosenberg, Sunnyvale, CA (US); Raymond G. Beausoleil, Redmond, WA (US); David A. Fattal, Mountain View, CA (US)

(72) Inventors: Marco Fiorentino, Mountain View, CA (US); Paul Kessler Rosenberg, Sunnyvale, CA (US); Raymond G. Beausoleil, Redmond, WA (US); David A. Fattal, Mountain View, CA (US)

(21) Appl. No.: 14/362,233

(22) PCT Filed: Jan. 9, 2012
(86) PCT No.: PCT/US2012/020625

§ 371 Date: Jun. 2, 2014

(51) Int. Cl. G02B 6/38; G02B 6/42

(52) U.S. Cl. CPC G02B 6/3855; G02B 6/42
USPC 385/78; 29/428

(57) ABSTRACT

Techniques related to optical connectors are described herein. In some examples, an optical connector is illustrated including a ferrule and a mating arrangement to mechanically attach the ferrule to an optical device. The mating element defines an insertion direction. The ferrule includes an optical pathway for light transmission through the ferrule. An end longitudinal section of the optical pathway is to optically couple the optical pathway to the optical device. The end longitudinal section is angled with respect to the insertion direction.

### BACKGROUND

Many applications depend on sending and receiving relatively large amounts of data. Technologies based on transmitting data using light are a convenient option that offers high network bandwidth. There are a number of devices that use light for transmitting information. For example, optical fibers are capable of transmitting data over vast distances providing high network bandwidth. Photonic integrated circuits (PIC) integrate multiple photonic functions providing functionality for light signals.

Optical connectors may be used where a connect/disconnect capability is required in an optical communication system. Optical connectors may be used to, for example, connect any kind of optical equipment such as waveguides (e.g., optical fibers), PICs, or optical transducers. For example, an optical connector may be used to interconnect optical fibers, or to connect an optical fiber to a PIC. Optical connectors may be designed for temporary interconnection of optical equipment. Alternatively, optical connectors may be designed for permanently or semi-permanently interconnect optical equipment.

Mechanical stability of optical connectors facilitates a reliable optical connection between optical components. An unstable optical connector may compromise continuity of an optical connection. Undesired disconnection between optical equipment may, at the least, cause user inconvenience. In some situations, undesired disconnection may imply disastrous consequences for the interconnected optical equipment.

### BRIEF DESCRIPTION OF THE DRAWINGS

In order that the present disclosure may be well understood, various examples will now be described with reference to the following drawings.

FIG. 1A is a perspective view of an optical system including a connector and a complementary optical device in a decoupled state; FIG. 1B is a perspective view of the optical system of FIG. 1A in a connected state.

FIGS. 2A and 2B are front views from different sides of the optical system of FIG. 1A in a decoupled state. FIGS. 2C and 2D are front views from different sides of the optical system of FIG. 1A in a connected state.

FIG. 3 is a cross-sectional view of a portion of an optical system including a connector and a complementary optical device shown in a decoupled state according to another example.

FIG. 4 is a cross-sectional view of a portion of an optical system including a connector and a complementary optical device shown in a decoupled state according to another example.

FIG. 5 is a perspective view of an optical system including a connector and a complementary optical device in a decoupled state according to a further example.

FIG. 6 is a cross-sectional view of a portion of an operating optical system including a connector and a complementary optical device shown in a coupled state according to another example.

FIG. 7 is a cross-sectional view of a portion of an operating optical system including a connector and a complementary optical device shown in a coupled state according to still another example.

FIG. 8 is a flow chart illustrating manufacturing of optical systems according to embodiments herein.

FIG. 9A is a cross-sectional view of an optical system in a decoupled state and a linking element. FIG. 9B is a cross-sectional view of the optical system of FIG. 9A in a connected state with the linking element inserted. FIG. 9C is a cross-sectional view of the optical system of FIG. 9A in a connected state with the linking element extracted.

### DETAILED DESCRIPTION

In the following, numerous details are set forth to provide an understanding of the examples disclosed herein. However, it will be understood that the examples may be practiced without these details. Further, in the following detailed description, reference is made to the accompanying figures, in which various examples are shown by way of illustration. While a limited number of examples are illustrated, it will be understood that there are numerous modifications and variations therefrom.

In this regard, directional terminology, such as “top,” “bottom,” “front,” “back,” “left,” “right,” “vertical,” etc., is used with reference to the orientation of the figures being described. Because disclosed components can be positioned in a number of different orientations, the directional terminology is used for purposes of illustration and is in no way limiting. In the drawings, the dimensions of layers and regions as well as some surface angles are exaggerated for clarity of illustration. Like numerals are used for like and corresponding parts of the various figures. While a limited number of examples are illustrated, it will be understood that there are numerous modifications and variations therefrom.

As set forth above, mechanical stability of optical connectors facilitates a reliable optical connection between optical components. For example, a mechanically unstable optical connector interfacing an optical fiber and a photonic integrated circuit (PIC) may cause that the optical path between the optical fiber and the PIC is interrupted during operation of this optical system. Optical path interruptions may cause user inconvenience or even damage to the optical components.

Optical waveguide connectors are described herein. The term “waveguide connector” refers to an optical device designed to interconnect two optical components through an optical waveguide. An optical waveguide is a physical structure for guiding an electromagnetic wavefront in the optical spectrum. Optical waveguide connectors may be provided with an optical waveguide disposed in an optical pathway or, alternatively, merely with an optical pathway configured to receive a waveguide therein.

As further detailed below, optical waveguide connectors may include a ferrule including an optical pathway for light transmission therethrough. A ferrule is a piece of a suitable material (such as, but not limited to, glass, ceramic, plastic or metal) including one or more optical pathways for light transmission through the ferrule. A ferrule may be formed by molding or any other suitable manufacturing method. In some examples, the ferrule is comprised of a precision molded plastic. As used herein, an “optical pathway” refers to any suitable structure or component of the ferrule configured to define the optical path of an optical signal through the ferrule. By way of example, the optical pathway may be adapted for receiving an optical fiber, or any other type of optical waveguide, for carrying a light signal. Further, the optical pathway may be adapted for receiving an active device such as, but not limited to, a vertical cavity surface emitting laser (VCSEL), a photo detector, or any other active optical device.

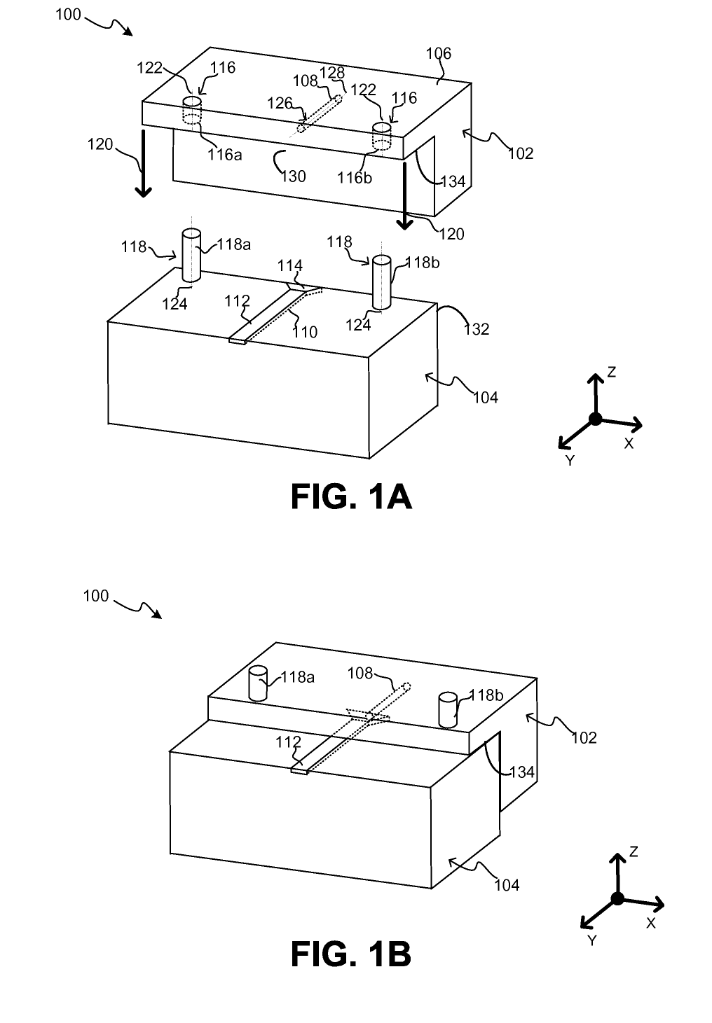

In at least some examples herein, the optical waveguide connector includes a mating arrangement to mechanically attach a ferrule, described above, to an optical device. In some examples, as illustrated in FIGS. 1A-7, the mating arrangement is formed at a ferrule of the connector. Alternatively, the mating arrangement may be provided at a piece attached to a ferrule of the connector. A mating arrangement refers to one or more mating elements disposed at a connector to mechanically couple the connector to a complementary device by effecting mating with a corresponding mating arrangement disposed at a device complementary to the connector.

Mating includes insertion of a mating element into a corresponding mating element. More specifically, a mating arrangement at the connector may include a receiving element (e.g., a hole) and the complementary device may include an insert element (e.g., a pin). In other examples, the mating arrangement at the connector may include an insertion element and the mating arrangement at the complementary device may include a receiving element. Further, a mating arrangement may include a combination of insertion and receiving elements. An example of a mating arrangement is a “pin-and-hole” arrangement that includes as mating elements one or more holes and corresponding pins. Mechanical coupling is performed by insertion of a pin into a corresponding hole.

In at least some examples, a mating arrangement is not only to mechanically attach a ferrule to a complementary optical device but also to align an optical pathway at the connector to a corresponding optical pathway at the complementary optical device.

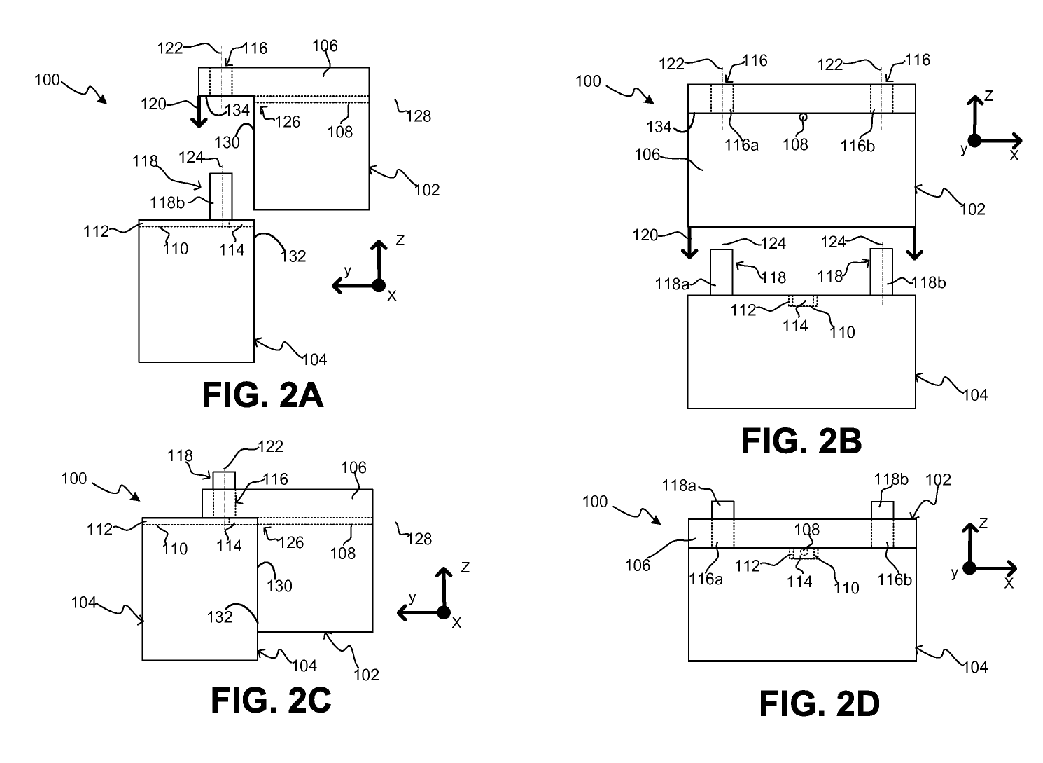

A mating arrangement defines an insertion direction. As used herein, the insertion direction refers to the direction along which a mating element of a connector is inserted into a corresponding mating element at a complementary optical device or vice versa (i.e. the direction along which a mating element of a complementary optical device is inserted into a corresponding mating element at a connector). For example, as further illustrated below, a mating arrangement may be based on a pin-and-hole design; a ferrule of the connector may include a hole that mates a corresponding pin in a complementary device; the longitudinal axis of the hole defines the insertion direction (see FIGS. 1A-2D). In other examples, a ferrule of the connector may include a pin that mates a corresponding hole in a complementary device.

In optical waveguides described herein, an end longitudinal section of an optical pathway is arranged to optically couple the optical path of the connector to a complementary optical device. For example, a connector may include a pathway with an optical fiber received therein; when the connector of this example is in a connected state with a complementary device, an end of the optical pathway may be aligned with a corresponding optical pathway in the complementary device so that an interconnecting optical path is defined between both devices; this interconnecting optical path realizes the optical coupling between the connector and the complementary device.

In examples herein the above referred pathway end longitudinal section is angled with respect to the insertion direction. For example, the end longitudinal section of the optical pathway may form an angle between 70° and 110° with the insertion direction or, more specifically, an angle between 80° and 100° such as 90°. More specifically, according to some examples, the connector is arranged such that the insertion direction and optical fiber end longitudinal section are substantially (i.e., within manufacturing tolerances) perpendicular each other. As further illustrated below, an angled configuration between the insertion direction and the end longitudinal section of an optical pathway of the connector facilitates mechanical stability of the connection. More specifically, in examples herein, an angled configuration facilitates a higher contact surface between the connector and a complementary device. A higher contact surface generally promotes mechanical stability of the connection. Moreover, an angled configuration closer to a right angle (e.g., an angle between 70° and 100°) facilitates construction of a mechanically stable and compact connector. Compact connectors are convenient for applications where space is at a premium.

The following description is broken into sections. The first section, labeled “Connectors,” illustrate examples of connectors and connector components. The second section, labeled “Manufacturing of connectors,” describes examples of methods for manufacturing connectors.

CONNECTORS: FIGS. 1A-2D illustrate an optical system 100 including a connector 102 and a complementary optical device 104. Complementary optical device 104 might also be viewed as a connector since it is designed for providing interconnectivity between optical elements (more specifically, between optical pathway 108 and planar waveguide 112). FIG. 1A is a perspective view of optical system 100 in a decoupled state. FIG. 1B is a perspective view of optical system 100 in a connected state. FIGS. 2A and 2B are front views from different sides of optical system 100 in a decoupled state: FIG. 2A is a front view from the x-axis; and FIG. 2B is a front view from the y-axis. FIGS. 2C and 2D are front views from different sides of optical system 100 in a connected state: FIG. 2C is a front view from the x-axis; and FIG. 2D is a front view from the y-axis.

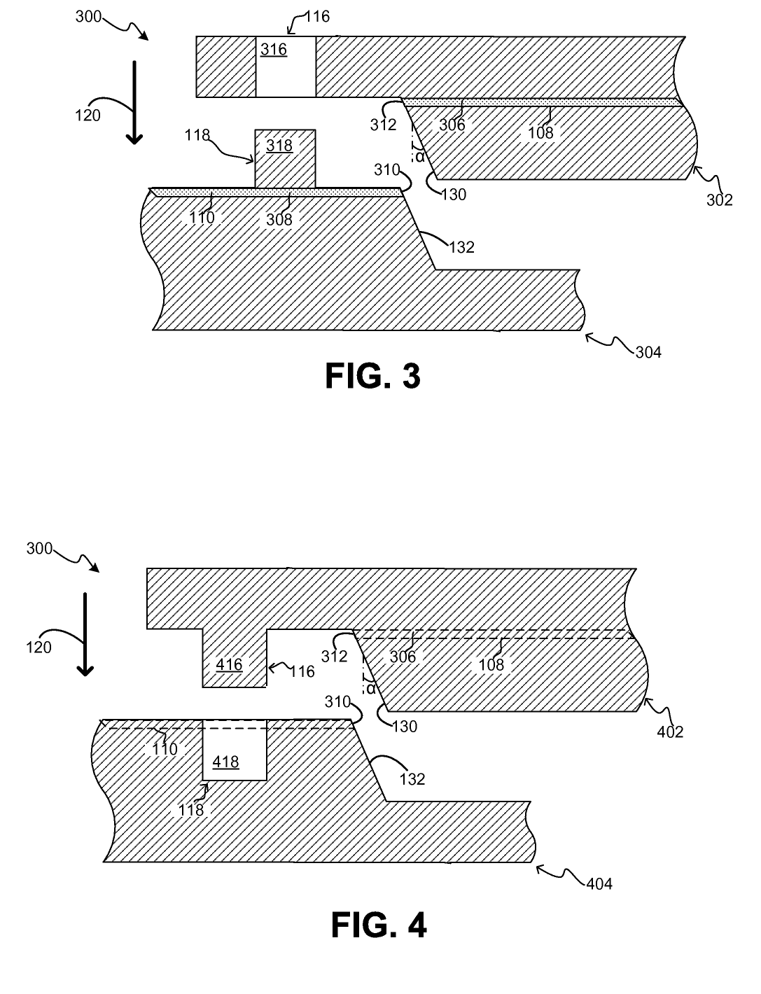

Connector 100 includes a ferrule 106. In the illustrated example, ferrule 106 is L-shaped. Ferrules with alternative shapes are illustrated below with respect to FIGS. 3 and 4. Generally, a ferrule of a connector as described herein may be formed according to any shape suitable to mechanically and optically couple the connector to a complementary device.

Ferrule 100 includes an optical pathway 108 for light transmission through the ferrule. More specifically, optical pathway 108 is dimensioned to receive an optical fiber (not shown in this Figure) therein. An optical pathway as described herein may be adapted for receiving a variety of waveguide types such as, but not limited to, a dielectric slab waveguide, a strip waveguide, or a rib waveguide. A dielectric slag waveguide may be comprised of three layers of materials with different dielectric constants, the material being chosen such that light is confined in the middle layer by total internal reflection. A strip waveguide may be comprised of a strip of a light guiding layer confined between cladding layers. In a rib waveguide, the light guiding layer is comprised of a slab with a strip (or several strips) superimposed onto it.

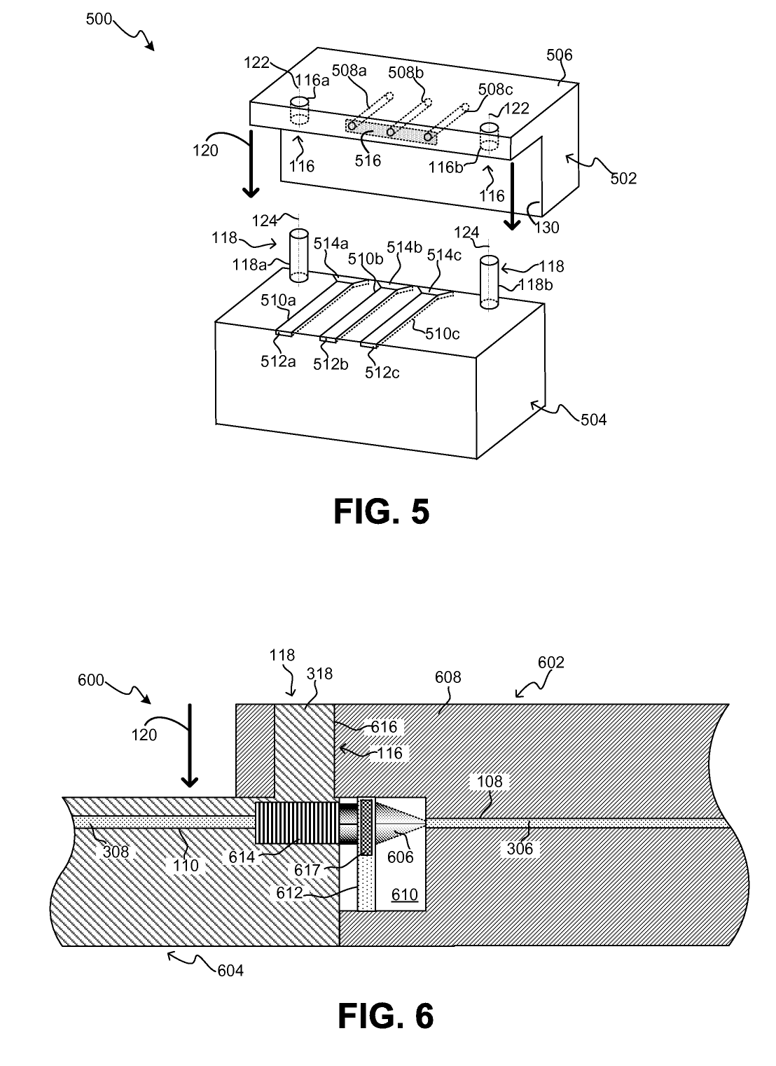

In the illustrated example, ferrule 106 is for a single terminal connector. More specifically, ferrule 106 is designed to be implemented in a connector for inter-connecting one input channel and one output channel. Therefore, ferrule 102 is adapted for receiving one optical fiber at optical pathway 108. In other examples, ferrules are adapted for a multiple terminal connector as illustrated below with respect to FIG. 5.

Ferrule 106 is adapted to be mechanically coupled to complementary optical device 104. In the illustrated example, complementary optical device 104 includes an optical pathway 110 into which a planar waveguide 112 is mounted. Planar waveguide 112 ends into a coupling element 114. Coupling element 114 is to couple light from an external device (in this case, from connector 102) into waveguide 112. In this example, coupling element 114 is illustrated as a tapered waveguide. Coupling element 114 may be any optical element suitable to couple light into a waveguide such as gratings or lenses.

A mating arrangement 116 is integrated in ferrule 106 to mechanically attach ferrule 106 to complementary optical device 104. More specifically, mating arrangement 116 is arranged to mate a corresponding mating arrangement 118 disposed at device 104.

Mating arrangements 116 and 118 are based on a “pin-and-hole” configuration. In this specific example, mating arrangement 116 includes holes 116a, 116b formed complementary to pins 118a, 118b of mating arrangement 118. Pins 118a, 118b (as well as other pins illustrated herein), may include a chamfer or the like (not shown) at the upper edges to facilitate alignment and prevent wear and debris formation during connection.

In the illustrated example, longitudinal axis 122 of holes 116a, 116b is parallel to longitudinal axis 124 of pins 118a, 118b. Longitudinal axes 122, 124 define an insertion direction 120. Pins 118a, 118b of mating arrangement 118 are inserted into holes 116a, 116b of mating arrangement 118, for mechanically coupling ferrule 102 to device 104. In this specific example, insertion is effected by translation of connector 102 along insertion direction 120. In other examples, insertion may be effected by translation of device 104 or by translation of both connector 102 and device 104.

In the illustrated example, mating arrangement 118 is integrated in ferrule 106. An integrated mating arrangement refers to a mating arrangement with mating elements formed in the body of ferrule 106. For example, as illustrated in the present example, holes 116a, 116b are formed in the body of ferrule 106. An integrated mating arrangement facilitates compactness and convenient manufacturing of a ferrule as described herein. In other examples, a mating arrangement is not integrated in a ferrule but provided with mating elements formed separated from the ferrule and attached or bonded to the body of the ferrule by any suitable means.

Mating arrangement 116 is not only arranged to mechanically attach ferrule 106 to complementary optical device 104 but it is also arranged to align optical pathway 108 at connector 102 to corresponding optical pathway 110 at complementary optical device 104. More specifically, as illustrated in FIGS. 1B, 2C-2D, when connector 102 is coupled to device 104 through insertion of pins 118a, 118b into holes 116a, 116b, optical pathway 108 is optically aligned with corresponding optical pathway 110 at device 104 so that light emitted from an optical fiber at optical pathway 108 is coupled into planar waveguide 112 through tapered waveguide 114. Optical system 100 (as well as other optical systems illustrated herein) may also operate in the reverse. That is, when optical system 100 is in the connected state, light transmitted by planar waveguide 112 towards tapered waveguide 114 and emitted therefrom may be coupled into an optical fiber at optical pathway 108 through tapered waveguide 114.

End longitudinal section 126 of optical pathway 108 is arranged to optically couple optical pathway 108 to complementary optical device 104. An end longitudinal section of an optical pathway (e.g., pathway 108) refers to a portion (e.g., portion 120) of the optical pathway, which portion extends along the longitudinal axis of the optical pathway and is arranged to be adjacent to, or close to, a corresponding optical pathway (e.g., pathway 110) at the complementary optical device (e.g., device 104) when optical system 100 is in a connected state. In the illustrated example, end longitudinal section 126 is a straight pathway portion extending along a longitudinal axis 128. End longitudinal section 126 abuts a surface 130 of ferrule 102. Surface 130 is herein referred to as optical connection surface since this is the surface of connector 100 on which corresponding optical paths of connector 102 and device 104 are interconnected when optical device 100 is in a connected state. Surface 130 is configured to confront a corresponding surface 132 of device 104 when optical system 100 is in a connected state. In the illustrated example, surfaces 130 and 132 are contiguous to each other when optical system 100 is in a connected state.

In this specific example, optical connection surface is substantially parallel to insertion direction 120. (The term ‘substantial’ indicates that the indicated spatial configuration takes into account manufacturing tolerances.) As illustrated below with respect to FIGS. 3, 4, an optical connection surface may be angled with respect to the insertion direction 120 in order to accommodate an oblique facet of an optical fiber received therein so that (i) back-reflections are prevented, and (ii) mechanical stability of the connector is further enhanced. For example, surface 130 may form an angle between −20° and 20° with insertion direction 120.

End longitudinal section 126, or more particularly axis 128, is angled with respect to insertion direction 120. In the illustrated example, end longitudinal section 126 is disposed perpendicular to insertion direction 120. In other examples, end longitudinal section 126 may form other angles with respect to insertion direction 120 such as an angle between 70° and 110° or, more specifically, an angle between 80° and 100° such as 90°. In the illustrated example, and other examples herein, mating arrangement 116 is formed at a surface 134 perpendicular to surface 130 (where optical pathway 108 abuts).

As can be best appreciated in FIGS. 2A, 2C, an angled configuration of connector 102 facilitates a relatively high contact surface between ferrule 106 and complementary device 104 since the mating arrangement and the optical pathway are arranged at different surfaces of the connector. Thereby, mechanical stability of the connection is promoted without compromising compactness of the connector device.

As set forth above, a variety of ferrule shapes are contemplated. In the example above an L-shaped ferrule is illustrated. In the examples of FIGS. 3-4, ferrules with oblique shapes are illustrated. FIG. 3 is a cross-sectional view of a portion of an optical system 300 including a connector 302 and a complementary optical device 304 according to another example. FIG. 3 shows optical system 300 in a decoupled state. Optical system 300 includes a number of elements that are analogous to elements in optical system 100 illustrated above with respect to FIGS. 1-2D. More specifically, connector 302 includes an optical pathway 108 and a mating arrangement 116, which includes a receiving element 316 formed as a hole. Further, device 304 includes an optical pathway 110 and a mating arrangement 118, which includes an insertion element 318 formed as a pin.

In addition to those elements, connector 302 includes an optical fiber 306 received into optical pathway 108. Further, device 304 includes an optical fiber 308 received into optical pathway 110. Optical system 300 is designed to establish an optical connection by a point-to-point contact between respective facets 310 and 312 of optical fibers 306 and 208. A facet refers to an end surface of an optical fiber. As seen in the Figures, optical connection surface 130 is configured to accommodate an oblique facet 310. An oblique facet refers to an optical fiber facet that is slightly off from the perpendicular with respect to the longitudinal axis of the optical fiber. An oblique angle prevents back-reflection of light into the optical fiber. Moreover, an optical connection surface angled for accommodating an oblique facet facilitates optical connection as well as mechanical stability of the connector by increasing the contact surface between connected components. As seen in FIGS. 3 and 4, in contrast to the previous example (i.e., optical system 100), optical system 300 includes an optical connection surface 130 that is oblique relative to insertion direction 120. More specifically, optical connection surface 130 (and facet 312) forms an angle a of 8° with respect to insertion direction 120 (angle is exaggerated in the Figure for the sake of illustration). As set forth above, angle a may adopt other values such as an angle value between −20° and 20°.

In the above examples, mating arrangements are based on a pin-and-hole configuration in which holes are provided in the connector (or, more specifically, on the ferrule) and pins are provided in the complementary device. In other examples herein, the mating arrangement of the connector may include insertion elements (e.g., pins). For example, insertion elements may be integrated into the ferrule as illustrated with respect to FIG. 4.

FIG. 4 is a cross-sectional view of a portion of an optical system 400 including a connector 402 and a complementary optical device 404. Optical system 400 is shown in a decoupled state. Optical system 400 includes a number of elements that are analogous to elements in optical system 300 illustrated above with respect to FIG. 3. More specifically, connector 402 includes an optical pathway 108 and a mating arrangement 116. Further, device 204 includes an optical pathway 110 and a mating arrangement 118.

In contrast to optical system 300, mating arrangement 116 at connector 402 includes an insertion element 416 formed as a pin. Further, mating arrangement 118 at device 404 includes a receiving element 418 formed as a hole. In other examples, not depicted in the figures, each of mating arrangements 116 and 118 may include a combination of insertion and receiving elements.

As set forth above, and illustrated with respect to FIG. 5, an optical connector as described herein may be a multiple terminal (MT) connector. A MT connector refers to a connector that can interconnect a plurality of input optical channels to a plurality of corresponding output optical channels.

FIG. 5 is a perspective view of an optical system 500 including a connector 502 and a complementary optical device 504 in a decoupled state according to a further example. Connector 502 includes a ferrule 506. Ferrule 506 is for a multiple terminal (MT) connector, namely, it includes a plurality of optical pathways. In this specific example, ferrule 500 is for a three terminal connector and, therefore, includes optical pathways 508a-508c formed analogously to optical pathway 108 illustrated above. Consequently, complementary optical device 504 includes a corresponding number of optical pathways 510a-510c formed analogously to optical pathway 110 illustrated above. More specifically, optical pathways are illustrated receiving, respectively, planar optical waveguides 512a-512c (formed analogously to planar waveguide 112) ending into coupling elements 514a-514c, in this example illustrated as tapered waveguides formed analogously to coupling element 114.

In examples herein, a MT connector may include a positioning arrangement defining an insertion direction angled with respect to end longitudinal sections of the optical pathways. In the illustrated example, ferrule 500 includes a positioning arrangement 116 with a pair of receiving elements 116a, 116b formed as holes. Device 504 includes a corresponding positioning arrangement 118 with a pair of insertion element 118a, 118b formed as pins. Longitudinal axes 122, 124 define insertion direction 120.

In this example, positioning arrangement 116 is to (i) mechanically couple connector 502 to device 504 and (ii) optically align optical pathways 108a-108c at connector 502 with optical pathways 110a-110c. End surfaces of pathways 108a-108c define an optical connection plane 516. In the illustrate example, optical connection plane 516 is coincident with optical connection surface 130 of connector 502. The end surfaces of pathways 108a-108c may be arranged to accommodate oblique facets of optical fibers received in the pathways. Similarly as illustrated above with respect to FIGS. 3, 4, the optical connection surface is also arranged to accommodate such oblique facets. In the illustrated example, the end longitudinal sections of pathways 108a-108c are angled (in this example perpendicularly angled) with respect to insertion direction 120. Such an angled configuration facilitates mechanical stability, which is particularly convenient for a MT connector since the higher the number of terminals, the higher the probability that an optical interconnection is interrupted due to mechanical instabilities.

Some examples herein contemplate expanded beam connectors. In an expanded beam connector, a light beam being interconnected is expanded in an interconnection interface. Generally, the beam is expanded by divergence. In contrast to point-to-point contact connectors, which may require an exact alignment of the channels susceptible to environmental changes or mechanical instabilities, expanded beam connectors are resilient to relative lateral displacements between the optical channels or other components of connector. Further, beam expansion may be used to adapt the light beam to interconnected optical pathways of different diameters. The combination of an angled connector configuration and beam expansion further prevents terminal interruption in an optical system.

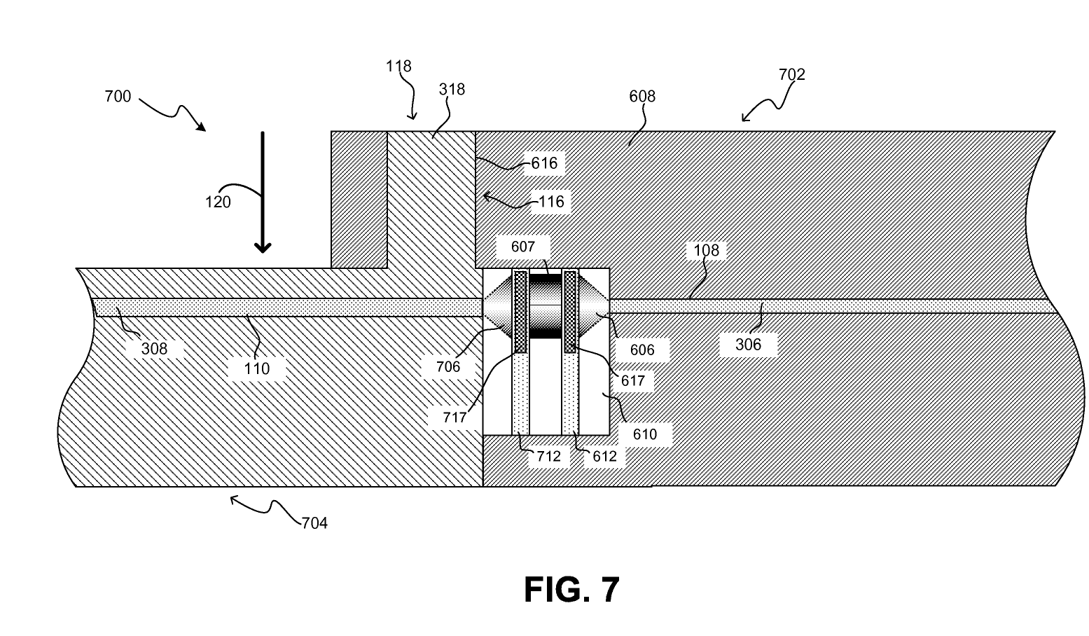

Generally, an expanded beam connector includes additional optical elements for adapting the optical beam to the interconnected components. For example, an arrangement of conventional lenses may be used to diverge, focus, or collimate the beam in the interconnecting interface. According to some examples herein, a sub-wavelength (SWG) assembly may be used to perform such optical functions as illustrated in FIGS. 6 and 7. More specifically, a connector as described herein may include a SWG arrangement aligned with respect to an optical pathway end and arranged to implement one or more specific optical functions in a connector such as, but not limited to, beam focusing, beam expansion, beam splitting, filtering of beam spectral components, beam polarization, or beam control (e.g., deflection of a beam).

A SWG assembly includes one or more SWG layers arranged to implement the specific optical functions referred to above. A SWG layer refers to a layer that includes a diffraction grating with a pitch that is sufficiently small to suppress all but the 0^{th} order diffraction. In contrast thereto, conventional wavelength diffraction gratings are characterized by a pitch that is sufficiently high to induce higher order diffraction of incident light. In other words, conventional wavelength diffraction gratings split and diffract light into several beams travelling in different directions. A pitch of a SWG layer may range from 10 nm to 300 nm or from 20 nm to 1 μm. How the SWG layer refracts an incident beam may be determined at manufacturing by properly selecting the dimensions of the diffractive structure of the SWG.

A SWG assembly facilitates implementing a vast variety of optical functionalities in an optical connector. More specifically, a SWG arrangement may provide optical functionalities analogous to those of conventional optical devices such as lenses, prisms, beam splitters, beam filters, or polarizers without compromising optical performance of the connector. Examples of SWG assemblies that may be implemented in examples herein are illustrated in the international patent application with publication number WO 2011/136759 and the US patent application with publication number US 2011/0188805, which are incorporated herein by reference to the extent in which these documents are not inconsistent with the present disclosure and in particular those parts thereof describing SWG design.

FIG. 6 is a cross-sectional view of a portion of an optical system 600 including a connector 602 and a complementary optical device 604 shown in a coupled state according to another example. Optical system 600 is shown in operation for interconnecting a light beam 606 between connector 602 and device 604.

Connector 602 includes a ferrule 608 with an optical pathway 108 and a mating arrangement 116, which includes a receiving element 616 formed as a hole. An optical fiber 306 is depicted received in optical path 108 for light transmission through ferrule 608. Optical pathway 108 abuts an interconnection region 610 disposed between ferrule 608 and device 604 when optical system 600 is in a coupled state as shown in the Figure. Interconnecting region 610 includes a SWG assembly 612 aligned with optical pathway 108

Device 604 includes optical pathway 110 and a mating arrangement 118 with an insertion element 318 formed as a pin. Optical pathway 110 includes a waveguide that terminates in a coupling element 614, in this example illustrated as a grating layer. Coupling element 614 is any suitable optical arrangement to optically couple light into or out of waveguide 308.

SWG assembly 612 is aligned with optical pathway 108 for coupling light beam 606, emitted from optical fiber 306, into optical pathway 110 of device 604. More specifically, SWG assembly 612 includes a SWG layer 617 arranged to collimate optical beam 606 into coupling element 614. SWG assembly 612 may include further or alternative SWG layers to implement other optical functions such as deflecting a beam, splitting a beam into spectral components, filtering one or more spectral components in a beam, polarizing a beam, focusing or defocusing a beam, collimating a beam with a non-parallel wavefront, or combination of such functions.

FIG. 7 is a cross-sectional view of a portion of an optical system 700 including a connector 702 and a complementary optical device 704 shown in a coupled state according to another example. Optical system 700 is shown in operation for interconnecting a light beam 606 between connector 702 and device 704. Optical system 700 includes a number of elements that are analogous to elements in optical system 600 illustrated above with respect to FIG. 6. More specifically, connector 702 includes a ferrule 608 with an optical pathway 108 and a mating arrangement 116, which includes a receiving element 616 formed as a hole. An optical fiber 306 is depicted received in optical path 108. An interconnecting region 610 includes a SWG assembly 612 aligned with optical pathway 108. Further, device 704 includes optical pathway 110, with an optical fiber 308 received therein, and a mating arrangement 118 with an insertion element 318 formed as a pin.

In contrast to the example illustrated in FIG. 6, interconnecting region 610 at connector 702 includes a further SWG assembly 712 aligned with SWG assembly 612. Further SWG assembly 712 is also arranged such that it is aligned with optical pathway 110 when connector 702 is coupled to device 704. More specifically, SWG assembly 712 includes a SWG layer 717 arranged to focus a light beam 706 into optical fiber 308 in optical pathway 110. SWG assembly 612 may include further or alternative SWG layers to implement other optical functions such as deflecting a beam, splitting a beam into spectral components, filtering one or more spectral components in a beam, polarizing a beam, focusing or defocusing a beam, collimating a beam with a non-parallel wavefront, or combination of such functions. Further, connector 702 may combine SWG assembly 612 and SWG assembly 712 in a single SWG assembly responsible for focusing diverging beam 606 into optical fiber 308 in an analogous manner as depicted by FIG. 7.

In operation of system 700, optical fiber 108 emits a diverging beam 606. Diverging beam 606 impinges on SWG layer 617 and is collimated into a collimated beam 607. Collimated beam 607 impinges on SWG layer 717 and is processed thereby into a converging beam 706 focused into optical fiber 308. A coupling element as illustrated in other examples (e.g., coupling element 114) can be obviated in this example, since converging beam 706 is focused such that its diameter at the entrance point of pathway 110 is sufficiently small. It will be understood that system 700 may be operated in the reverse, i.e., for coupling a light beam emitted from fiber 308 of device 704 into fiber 306 of connector 702.

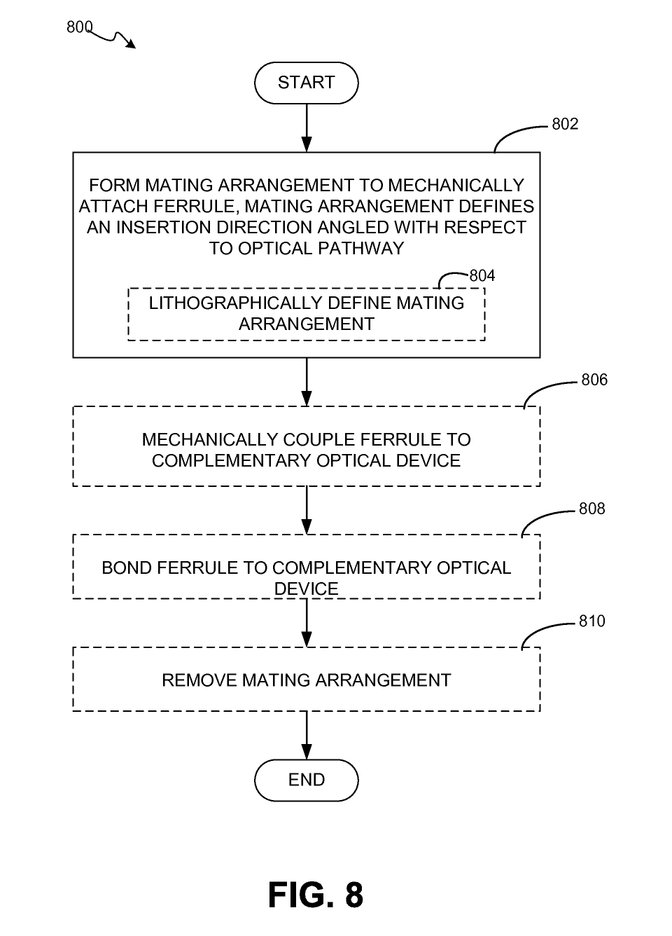

MANUFACTURING OF CONNECTORS: FIG. 8 depicts a method 800 illustrating examples of manufacturing optical systems that may include a connector and, optionally, a complementary optical device. For example, the optical systems may be comprised of connectors 102, 302, 402, 502, 602, 702 illustrated above with respect to FIGS. 1-7. At block 802, a mating arrangement is formed. The mating arrangement defines an insertion direction. For example, referring back to FIG. 1A, longitudinal axis 122 of hole 116 defines insertion direction 120. The mating arrangement is formed such that it is configured to mechanically attach a ferrule (e.g., ferrule 106) to a complementary optical device (e.g., device 104) by insertion along the insertion direction. Further, the ferrule includes an optical pathway (e.g., pathway 108) for light transmission through the ferrule. An end longitudinal section of the optical pathway (e.g., section 126) is arranged to optically couple the optical pathway to the complementary optical device. The mating arrangement is formed such that the pathway end is angled with respect to the insertion direction.

The mating arrangement may correspond to any of the mating arrangement described above. There is a variety of processes available to form the mating arrangement. For example, receiving elements such as holes of the mating arrangement may be bored into portions of the ferrule. Alternatively, if the ferrule is manufactured by molding, holes may be formed during molding using spacers that can be washed out or extracted for forming a void space in the ferrule. Insertion elements, such as pins, may be formed as individual elements (e.g., by precision machining) and integrated into the ferrule by any suitable manufacturing process. For example, guide pin bores may be manufactured in the ferrule and pins may be inserted therein. The pins may be held in place by bonding or through a pin retainer element coupled to the ferrule. Alternatively, alignment pins may be monolithically formed in the ferrule. For example pins may be molded into or machined from the body of the ferrule.

Forming a mating arrangement at block 802 may include a sub-block 804 of lithographically defining the mating arrangement on a surface of the ferrule. Thereby, a high-precision definition of the position of elements in the mating arrangement is facilitated. A precise definition of mating elements further contributes to the mechanical stability of the connector and to a precise optical alignment of interconnected elements. For example, if the mating arrangement includes pins, the pins may be formed by the following process. First, a portion of the ferrule body may be coated with a layer of suitable material (a silicon, a silicon oxide, a metal, or a glass). Subsequently, the layer may be patterned using a suitable mask to form the pins, or pin precursors on which pins may be bonded.

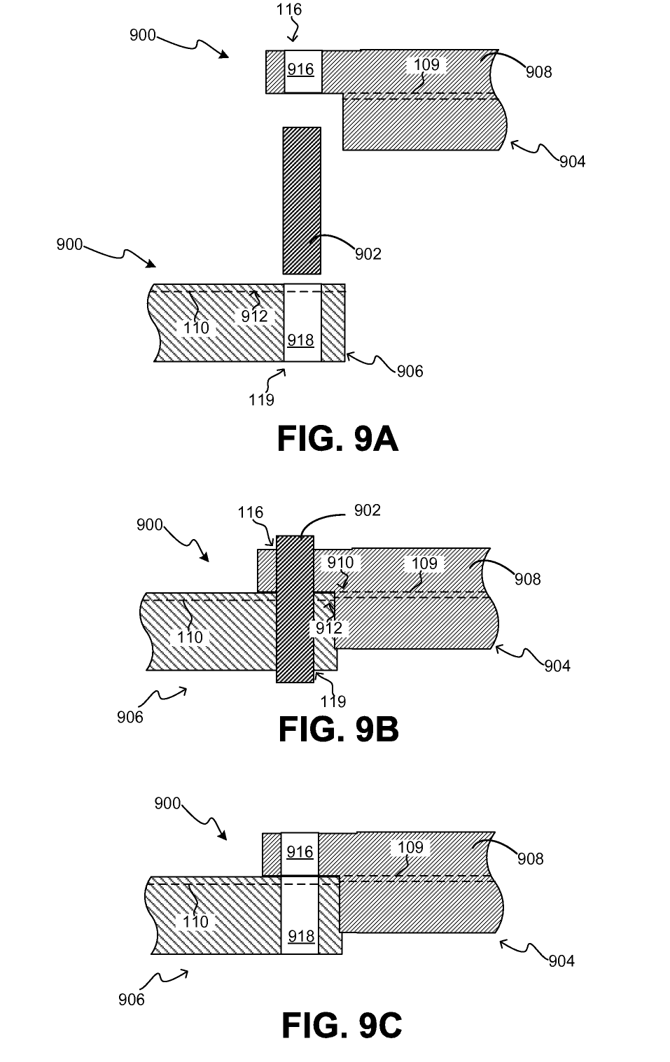

The optical system resulting from method 800 may be a stand-alone connector. In other examples, the optical system resulting from method 800 is comprised of a connector (e.g., connectors 102, 302, 402, 502) and complementary optical devices (e.g., devices 104, 304, 404, 504, 604). By way of example, method 800 depicts further blocks (i.e., blocks 806-810) for manufacturing an optical system resulting from integrating the connector and a complementary optical element. These further blocks are illustrated below, by way of example, with respect to FIGS. 9A-9C.

At block 806 the ferrule referred to above with respect to block 802 is mechanically coupled to a complementary optical device. There is a number of ways of performing the mechanical coupling of block 806. How the mechanical coupling is performed generally depends on the specific connector design. In some examples, the mechanical coupling is realized by engaging a mating arrangement of the complementary optical device to the mating arrangement of the ferrule. For example, as illustrated with respect to FIGS. 1A-7, a connector and a complementary optical device may include complementary mating arrangements (e.g., a pin and a corresponding hole). The connector and the complementary optical device positioned and displaced relative to each other such that the complementary mating arrangements are engaged. A further displacement may be imparted to effect insertion of insertion elements into the receiving elements until (a) the mechanical connection between the connector and the complementary device is stable, and (b) the elements to be optically interconnected are optically aligned.

FIGS. 9A-9C illustrate further examples of how coupling can be effected, in which an auxiliary mating arrangement may be used for coupling mating arrangements at the connector and the complementary optical device. FIG. 9A is a cross-sectional view of an optical system 900 in a decoupled state and a linking element 902 that acts as a further mating arrangement. FIG. 9B is a cross-sectional view of optical system 900 in a connected state with linking element 902 inserted. FIG. 9C is a cross-sectional view of optical system 900 in a connected state with linking element 902 extracted.

Optical system 900 includes a connector 904 and a complementary optical device 906. Connector 904 and device 906 include respective optical pathways 108, 110 arranged to be optically coupled when optical system is in a connected state (see FIGS. 9B, 9C). Optical pathway 108 is formed in a ferrule 908. In this specific example, optical coupling is realized by point-to-point contact of ends 910, 912 of optical pathways 108, 110. Connector 904 includes a mating arrangement 116, which includes a receiving element 916 formed as a hole. Device 906 includes a mating arrangement 118, which includes a receiving element 918 formed also as a hole. Both mating arrangements 916, 918 are arranged to mate linking element 902, which in this example is formed as a pin.

In the example illustrated in FIGS. 9A-9C, block 806 may be realized by bringing together connector 904 and device 906, with linking element 902 inserted in receiving elements 916, 918. Thereby, it is facilitated an accurate optical alignment of the optical elements to be interconnected (in this example, optical pathways 108, 110).

As illustrated by FIG. 9B, mechanically coupling the ferrule to the complementary optical device at block 806 includes aligning optical pathway 110 of complementary optical device 906 to optical pathway 108 of ferrule 908 such that adjacent end portions 910, 912 of optical pathways 110, 112 are arranged parallel to each other. Thereby, point-to-point contact of the pathways (or, more specifically, of waveguides received therein) may be realized.

In other examples, interconnecting elements (such as coupling element 114, or SWG assembly 612) are interposed between waveguides at the optical pathways for facilitating optical interconnection in the optical system. More specifically, referring back to the examples of FIGS. 1A-2D, and 5-7, mechanically coupling a ferrule (e.g., ferrule 106, 506, 606, or 706) to a complementary optical device (e.g., device 104, 504, or 604) may include optically aligning an optical pathway (e.g., pathway 110, or 510a-510c) of the complementary optical device to the optical pathway (e.g., pathway 108, or 508a-508c) of the ferrule through a coupling element (e.g., tapered waveguide 114, 514a-514c, 614) at an end of the optical pathway of the complementary device. Further, referring back to the example of FIG. 6, mechanically coupling the ferrule (e.g., ferrule 608) to the complementary optical device (e.g., device 604) at block 806 may include optically aligning an optical pathway (e.g., pathway 110) of the complementary optical device to the optical pathway (e.g., pathway 108) of the ferrule through a sub-wavelength assembly (e.g., SWG assembly 612).

In some examples herein, after mechanical coupling at block 806, the ferrule is bonded to the complementary optical device. For example, ferrule 908 and device 906 may be bonded at block 808 to each other in the arrangement depicted in FIG. 9B. Mating arrangements 116 and 118, in collaboration with linking element 902, facilitate that the bonding is performed with high positioning accuracy so that optical alignment of pathways 108, 110 is not compromised during the bonding process. For performing bonding, portions of ferrule 906 and device 906 may by coated with a suitable adhesive prior to mechanical coupling at block 806, these portions being arranged to be adjacent when system 900 is connected. In some embodiments, portions of the mating arrangements are provided with such an adhesive, in particular if these portions are to be in contact when the optical system is ready to be operated.

In some examples, after the bonding at block 908, a mating arrangement is removed. For example, in the examples illustrated above with respect to FIGS. 1A-7 the illustrated pins may be provided as removable elements and be removed when the optical system is in a connected stated with its components being bonded. In other examples, such as illustrated by FIGS. 9A-9C, an auxiliary mating arrangement (in this case linking element 902) is removed after the bonding at block 808. A removable mating arrangement facilitates high alignment accuracy of a fixed connector without compromising geometry or weight constraints to be met by an optical system.

At least some of the examples described above provide optical connectors. As discussed above, some of the examples may be successfully deployed in optical connectors based on optical fiber. However, some other examples may also be used for any type of optical device providing interconnectivity between optical components. Further, connectors illustrated above include mating arrangements based on a pin-and-hole configuration. However, a mating arrangement as contemplated herein may include any element suitable for implementing alignment of a ferrule with a complementary optical device such as appropriately arranged holes, slots, or sockets as well as corresponding insertion elements.

In the foregoing description, numerous details are set forth to provide an understanding of the examples disclosed herein. However, it will be understood by those skilled in the art that the examples may be practiced without these details. While a limited number of examples have been disclosed, those skilled in the art will appreciate numerous modifications and variations therefrom. It is intended that the appended claims cover such modifications and variations as fall within the true spirit and scope of the disclosed examples.

What is claimed is:

1. An optical waveguide connector comprising:
a ferrule including an optical pathway for light transmission through the ferrule; and
a mating arrangement to mechanically attach the ferrule to a complementary optical device, the mating element defining an insertion direction, and
an end longitudinal section of the optical pathway to optically couple the optical pathway to the optical device, said end longitudinal section being angled with respect to the insertion direction.

2. The connector of claim 1, wherein the mating arrangement is integrated in the ferrule

3. The connector of claim 2, wherein the mating arrangement includes a hole arrangement formed in the ferrule.

4. The connector of claim 1, wherein the connector is to connect multiple terminals, the ferrule including a plurality of pathways, end longitudinal sections of the plurality of pathways to optically couple the optical pathways to the optical device, said pathway end longitudinal sections being angled with respect to the insertion direction.

5. The connector of claim 1, further comprising a sub-wavelength grating arrangement aligned with respect to said optical pathway end longitudinal section so as to implement beam expansion.

6. The connector of claim 1, the end longitudinal section of the optical pathway forming an angle between 70° and 110° with the insertion direction.

7. A ferrule for an optical waveguide connector comprising:
an optical pathway for light transmission through a ferrule body;
a mating arrangement defining an insertion direction;
an optical pathway end to optically couple the optical pathway to a complementary optical device, said optical pathway end abutting an optical connection surface of the ferrule forming an angle between −20° and 20° with the insertion direction.

8. The optical fiber ferrule of claim 7, wherein the optical pathway is to receive an optical fiber with an oblique facet.

9. A method of manufacturing an optical system, the method comprising:
forming a mating arrangement at a connector, the mating arrangement to mechanically attach a ferrule of the connector to a complementary optical device, the mating arrangement defining an insertion direction, the ferrule including an optical pathway for light transmission through the ferrule, an end longitudinal section of the optical pathway to optically couple the optical pathway to the complementary optical device, wherein
the mating arrangement is formed such that the insertion direction is angled with respect to said pathway end.

10. The method of claim 9, wherein disposing the mating arrangement includes lithographically defining the mating arrangement on a surface of the ferrule.

11. The method of claim 9, further comprising mechanically coupling the ferrule to the complementary optical device by engaging a mating arrangement of the complementary optical device to the mating arrangement of the ferrule.

12. The method of claim 11, further comprising
bonding the ferrule to the complementary optical device, and
removing a mating arrangement.

13. The method of claim 11, wherein mechanically coupling the ferrule to the complementary optical device includes aligning an optical pathway of the complementary optical device to the optical pathway of the ferrule such that adjacent end portions of the optical pathways are arranged parallel to each other.

14. The method of claim 11, wherein mechanically coupling the ferrule to the complementary optical device includes optically aligning an optical pathway of the complementary optical device to the optical pathway of the ferrule through a coupling element at the complementary optical device.

15. The method of claim 14, wherein mechanically coupling the ferrule to the complementary optical device includes optically aligning an optical pathway of the complementary optical device to the optical pathway of the ferrule through a sub-wavelength assembly.
